(19) United States
(12) Patent Application Publication
(10) Pub. No.: US 2024/0062419 A1
(43) Pub. Date: Feb. 22, 2024

(54) 3D POSE ESTIMATION APPARATUS BASED ON GRAPH CONVOLUTION NETWORK, POSE ESTIMATION METHOD, AND RECORDING MEDIUM FOR PERFORMING THE SAME

(71) Applicant: Foundation of Soongsil University-Industry Cooperation, Seoul (KR)

(72) Inventors: Gye-young KIM, Anyang-si (KR); Minseok KIM, Gwangmyeong-si (KR)

(73) Assignee: Foundation of Soongsil University-Industry Cooperation, Seoul (KR)

(21) Appl. No.: 18/447,066

(22) Filed: Aug. 9, 2023

(30) Foreign Application Priority Data
Aug. 19, 2022 (KR) 10-2022-0104114
Sep. 8, 2022 (KR) 10-2022-0113988

(51) Int. Cl. G06T 7/73

(52) U.S. Cl. CPC G06T 7/75; G06T 2207/20084

(57) ABSTRACT

Provided is a pose estimation method in a 3D pose estimation apparatus for estimating a 3D pose of an object based on a graph convolution network (GCN). The pose estimation method comprises inputting a feature vector for a joint of the object; generating an affinity matrix according to the feature vector; generating a dynamic graph matrix by fusing the affinity matrix with a predefined static graph matrix of the graph convolution network; and estimating a 3D pose of the object for the feature vector by replacing the static graph matrix of the graph convolution network with the dynamic graph matrix. As a result, the performance of estimating a 3D pose can be greatly improved while almost maintaining the memory usage and inference time of the existing graph convolution network (GCN).

### CROSS-REFERENCE TO RELATED APPLICATIONS

This application claims the benefit of Korean Application Nos. 10-2022-0104114, filed Aug. 19, 2022, and 10-2022-0113988, filed Sep. 8, 2022, in the Korean Intellectual Property Office. All disclosures of the document named above are incorporated herein by reference.

### TECHNICAL FIELD

The present invention relates to a 3D pose estimation apparatus based on a graph convolution network, a pose estimation method, and a recording medium for performing the same, and more particularly, it relates to a 3D pose estimation apparatus based on a graph convolution network, in which the performance of pose estimation can be improved while maintaining the memory usage and inference time of the graph convolution network, a pose estimation method, and a recording medium for performing the same.

### BACKGROUND ART

Estimating a 3D pose from an image is a key component of computer vision, and these computer vision technologies are widely applied to technologies such as intelligent sports, motion recognition, human-computer interaction (HCl), motion capture, and augmentation/virtual reality.

Representative methods for estimating a 3D pose include direct regression approaches and 2D-to-3D lifting approaches.

First, the direct regression method is a method of predicting 3D joint coordinates directly from an image using a convolution neural network (CNN) or the like.

On the other hand, the 2D-to-3D lifting approach is currently the most widely used method, and is a method of converting the 2D joint coordinates into 3D joint coordinates after predicting the 2D joint coordinates from an image.

At this time, converting the 2D joint coordinates to the 3D joint coordinates is more difficult than predicting the 2D joint coordinates due to problems such as depth ambiguity, self-occlusion, and pixel to millimeters.

To solve this problem, recently, graph convolution neural networks (GCN), which are effective in learning human body pose features, are used. The GCN is suitable for application to 2D-to-3D lifting methods because it reinforces each other's features in a way that joint features interact with each other along the graph structure. As proof, most of the models using the GCN achieved good results in pose estimation evaluation.

A GCN layer applied with the GCN generally uses a graph matrix generated using a predefined graph structure and learnable static edge weights. Also, the artificial neural network, to which the GCN layer is applied, shows a structure similar to that of FIG. 1, because the GCN layer has a general design principle for human body pose estimation.

However, this method, to which the GCN layer is applied, also has limitations. When distortion occurs due to occlusion or noise in 2D joint coordinates given as input on an existing GCN layer composed of one graph matrix, it is difficult to flexibly process the distorted input. Therefore, the processing capability for various data cases is degraded, and a solution to this problem is needed.

### Related Patent Literature

Korean Patent Registration No. 10-1925879

### DISCLOSURE

### Technical Problem

The present invention has been made to solve the above problems, and an object of the present invention is to provide a 3D pose estimation apparatus based on a graph convolution network, in which the performance of estimating a 3D pose can be greatly improved while almost maintaining the memory usage and inference time of the existing graph convolution network (GCN), a pose estimation method, and a recording medium for performing the same.

### Technical Solution

In order to achieve the above object, according to an embodiment of the present invention, a pose estimation method in a 3D pose estimation apparatus for estimating a 3D pose of an object based on a graph convolution network (GCN) comprises inputting a feature vector for a joint of the object; generating an affinity matrix according to the feature vector; generating a dynamic graph matrix by fusing the affinity matrix with a predefined static graph matrix of the graph convolution network; and estimating a 3D pose of the object for the feature vector by replacing the static graph matrix of the graph convolution network with the dynamic graph matrix.

The generation of the affinity matrix may comprise predicting a weight to be applied to a plurality of predefined expert matrices by applying a routing function to the feature vector; and generating the affinity matrix as a weighted sum of the predicted weight and the plurality of expert matrices.

The generation of the dynamic graph matrix may comprise generating the dynamic graph matrix by performing a multiplication modulation using an element-by-element multiplication operation of the affinity matrix and the predefined static graph matrix.

The generation of the dynamic graph matrix may comprise generating the dynamic graph matrix by performing an additional modulation using a summation operation of the affinity matrix and the predefined static graph matrix.

The generation of the dynamic graph matrix may comprise generating the dynamic graph matrix using only the affinity matrix.

The generation of the dynamic graph matrix comprises calculating a transposition affinity matrix by performing a transposition operation on the dynamic graph matrix; and calculating a regular symmetric affinity matrix using an average operation of the dynamic graph matrix and the transposition affinity matrix, and estimating the 3D pose of the object may comprise estimating the 3D pose of the object for the feature vector by replacing the static graph matrix with the regular symmetric affinity matrix.

To achieve the above object, a computer program for performing the pose estimation method according to an embodiment of the present invention may be recorded on a computer-readable recording medium.

To achieve the above object, according to an embodiment of the present invention, a 3D pose estimation apparatus for estimating a 3D pose of an object based on a graph convolution network (GCN) comprises an affinity generation unit for inputting a feature vector for a joint of the object and generating an affinity matrix according to the feature vector; an affinity fusion unit for generating a dynamic graph matrix by fusing the affinity matrix with a predefined static graph matrix of the graph convolution network; and a pose estimation unit for estimating a 3D pose of the object for the feature vector by replacing the static graph matrix of the graph convolution network with the dynamic graph matrix.

The affinity generation unit may predict a weight to be applied to a plurality of predefined expert matrices by applying a routing function to the feature vector and generate the affinity matrix as a weighted sum of the predicted weight and the plurality of expert matrices.

The affinity fusion unit may generate the dynamic graph matrix by performing a multiplication modulation using an element-by-element multiplication operation of the affinity matrix and the predefined static graph matrix.

The affinity fusion unit may generate the dynamic graph matrix by performing an additional modulation using a summation operation of the affinity matrix and the predefined static graph matrix.

The affinity fusion unit may generate the dynamic graph matrix using only the affinity matrix.

The affinity fusion unit may calculate a transposition affinity matrix by performing a transposition operation on the dynamic graph matrix and calculate a regular symmetric affinity matrix using an average operation of the dynamic graph matrix and the transposition affinity matrix, and the pose estimation unit may estimate the 3D pose of the object for the feature vector by replacing the static graph matrix with the regular symmetric affinity matrix.

### Advantageous Effects

According to one aspect of the present invention described above, by providing a 3D pose estimation apparatus based on a graph convolution network, a pose estimation method, and a recording medium for performing the same, the performance of estimating a 3D pose can be greatly improved while almost maintaining the memory usage of and the inference time an existing graph convolution network (GCN).

### DESCRIPTION OF DRAWINGS

These and/or other aspects will become apparent and more readily appreciated from the following description of the embodiments, taken in conjunction with the accompanying drawings in which:

FIG. 1 is a schematic diagram showing the structure of an artificial neural network to which a GCN layer is applied;

FIG. 2 is a block diagram for describing the configuration of a 3D pose estimation apparatus according to an embodiment of the present invention;

FIG. 3 is a schematic diagram for describing a 3D pose estimation apparatus according to an embodiment of the present invention;

FIG. 4 is a flowchart for describing a pose estimation method in a 3D pose estimation apparatus according to an embodiment of the present invention, and

FIGS. 5 to 9 are experimental results for describing the effect of the pose estimation method according to an embodiment of the present invention.

### DETAILED DESCRIPTION OF EMBODIMENTS

The detailed description of the present invention which follows refers to the accompanying drawings which illustrate, by way of illustration, specific embodiments in which the present invention may be practiced. These embodiments are described in sufficient detail to enable those skilled in the art to practice the present invention. It should be understood that the various embodiments of the present invention are different from each other but are not necessarily mutually exclusive. For example, specific shapes, structures, and characteristics described herein may be implemented in another embodiment without departing from the spirit and scope of the invention in connection with one embodiment. Additionally, it should be understood that the location or arrangement of individual components within each disclosed embodiment may be changed without departing from the spirit and scope of the invention. Accordingly, the detailed description set forth below is not to be taken in a limiting sense, and the scope of the present invention, if properly described, is limited only by the appended claims, along with all equivalents as claimed by those claims. Like reference numbers in the drawings indicate the same or similar function throughout the various aspects.

Components according to the present invention are components defined not by physical division but by functional division, and may be defined by the functions each performs. Each of the components may be implemented as hardware or program codes and processing units that perform respective functions, and the functions of two or more components may be implemented by being included in one component. Therefore, the names given to the components in the following embodiments are not to physically distinguish each component, but to imply the representative function performed by each component, and it should be noted that the technical idea of the present invention is not limited by the names of the components.

Hereinafter, preferred embodiments of the present invention will be described in more detail with reference to the drawings.

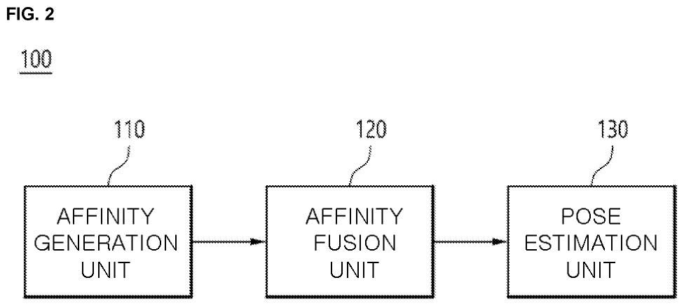

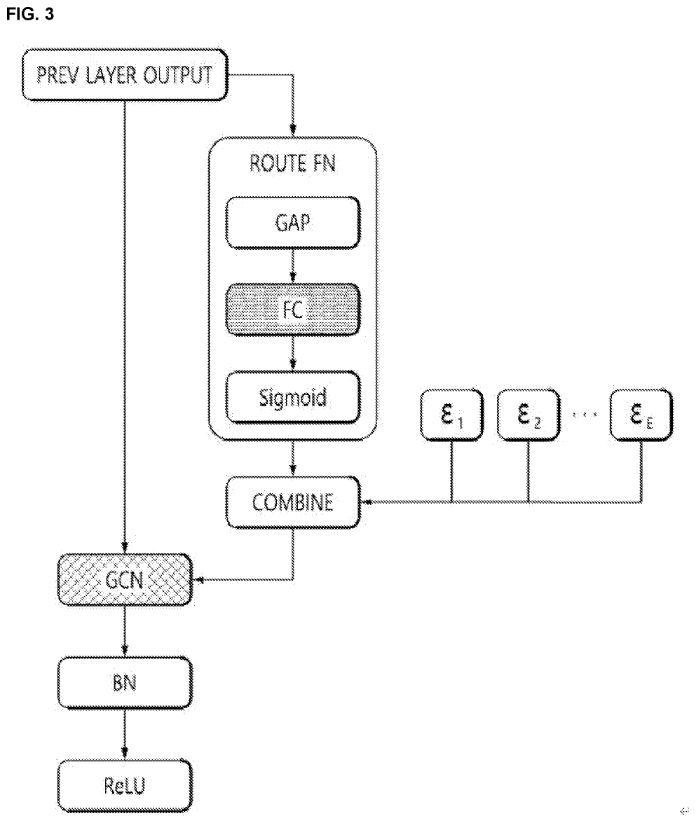

FIG. 2 is a block diagram for describing the configuration of a 3D pose estimation apparatus 100 according to an embodiment of the present invention, and FIG. 3 is a schematic diagram for describing the 3D pose estimation apparatus 100 according to an embodiment of the present invention.

The 3D pose estimation apparatus 100 according to the present embodiment (hereinafter referred to as the apparatus) is provided to estimate a 3D pose of an object from an image based on a graph convolution network (GCN). In addition, the apparatus 100 may install and execute software (application) for performing the 3D pose estimation method.

In addition, the apparatus 100 may receive the 2D joint coordinates of the object as an input. To this end, the apparatus 100, although not shown in the drawing, may comprise a communication unit and a storage unit, and may further comprise a configuration that can extract 2D joint coordinates from an image and calculate feature vectors for the joints of the object from the 2D joint coordinates.

The apparatus 100 may comprise an affinity generation unit 110, an affinity fusion unit 120, and a pose estimation unit 130 to estimate a 3D pose based on a feature vector.

The affinity generation unit 110 may receive a feature vector for a joint of an object and generate an affinity matrix according to the feature vector.

The affinity generation unit 110 may predict weights to be applied to a plurality of predefined expert matrices by applying a routing function (ROUTE FN) to the feature vector.

Also, the affinity generation unit 110 may generate an affinity matrix as a weighted sum of the predicted weights and the plurality of expert matrices.

Specifically, as shown in Equation 1 below, the affinity generation unit 110 may predict weights W to be applied to E expert matrices by applying a feature vector, which is a joint feature for each node of the graph, to a routing function (ROUTE FN) as an input vector h. Here, the expert matrices may mean several static graph matrices that can be learned.

W=Route(h) [Equation 1]

Here, the routing function (ROUTE FN) may comprise a Global Average Pooling layer (GAP), a Fully Connected layer (FC), and a Sigmoid activation function layer (Sigmoid), as shown in FIG. 3.

And, the affinity matrix ϵ_{cond}∈ [symbol] for the input vector h∈ [symbol] can be expressed as in Equation 2 below.

$${ε}_{cond} = {\sum }_{i = 1}^{E} {W}_{i} {ε}_{i} \qquad [ Equation 2 ]$$

Here, Wᵢ is the ith element (i∈{1, . . . , E}) of W∈ [symbol] , and ϵᵢ∈ [symbol] denotes a learnable static graph matrix. And, is a constant that represents the number of expert matrices and can be given as a hyperparameter.

Meanwhile, the affinity fusion unit 120 may be provided to apply the affinity matrix generated by the affinity generation unit 110 to a graph matrix used in a graph convolution network (GCN). To this end, the affinity fusion unit 120 may perform affinity modulation to modulate the affinity matrix.

Specifically, the affinity fusion unit 120 may generate a dynamic graph matrix by fusing the affinity matrix with a predefined static graph matrix of the graph convolution network.

In this case, the predefined static graph matrix may mean a feature based on a general skeletal structure of the human body. In addition, the affinity matrix generated by the affinity generation unit 110 may mean features of only objects in the image.

In other words, the predefined static graph matrix is based on a universal human body structure, and the affinity matrix may mean gender, age, or a unique structure that only a corresponding object has.

To this end, the affinity fusion unit 120 according to an embodiment of the present invention may generate a dynamic graph matrix in various ways.

As an embodiment, the affinity fusion unit 120 may generate a dynamic graph matrix by performing a multiplication modulation using an element-by-element multiplication operation of an affinity matrix and a predefined static graph matrix, which can be expressed as in Equation 3 below.

Aₘᵤₗ=Aₛₖₑₗₑₜₒₙ⊙ϵ_{cond} [Equation 3]

Here, Aₘᵤᵢ denotes a dynamic graph matrix generated through a multiplication operation, and Aₛₖₑₗₑₜₒₙ denotes a predefined static graph matrix.

Generation of a dynamic graph matrix according to this embodiment may be a method of adjusting only edge weights while maintaining a basic skeletal structure of a predefined static graph matrix.

According to another embodiment, the affinity fusion unit 120 may generate a dynamic graph matrix by performing an additional modulation using a summation operation of an affinity matrix and a predefined static graph matrix, which can be expressed as in Equation 4 below.

A_{add}=Aₛₖₑₗₑₜₒₙ+ϵ_{cond} [Equation 4]

Here, A_{add} denotes a dynamic graph matrix generated through a summation operation, and in generating a dynamic graph matrix according to the present embodiment, the affinity matrix can be modulated by increasing or decreasing the number of edges of a predefined static graph matrix.

Also, according to another embodiment, the affinity fusion unit 120 may generate a dynamic graph matrix using only the affinity matrix without using a predefined static graph matrix, which can be expressed as in Equation 5 below.

Aₙₒ₋ₛₖₑₗₑₜₒₙ=ϵ_{cond} [Equation 5]

That is, Aₙₒ₋ₛₖₑₗₑₜₒₙ may mean skeleton-free modulation that does not use a predefined static graph matrix at all.

Among the above-mentioned affinity modulation schemes, A_{add} generated by the summation operation and Aₙₒ₋ₛₖₑₗₑₜₒₙ generated by the skeleton-free modulation secure robustness to various data cases because they use a skeleton different from the predefined static graph matrix.

Alternatively, the affinity fusion unit 120 may use only a predefined static graph matrix without using the generated affinity matrix. That is, modulation may not be performed.

Meanwhile, if an unexpected matrix is generated in the process of performing an affinity modulation according to the various methods described above, it may adversely affect the estimation of the overall 3D pose.

To this end, the affinity fusion unit 120 may add a regular symmetric constraint in consideration of the symmetry of the human skeletal structure.

Specifically, the affinity fusion unit 120 may calculate a transposition affinity matrix by performing a transposition operation on the dynamic graph matrix.

Also, the affinity fusion unit 120 may calculate a regular symmetric affinity matrix using an average operation of the dynamic graph matrix and the transposition affinity matrix. This can be expressed in Equation 6 below.

Reg(A)=(A+A^{T})/2 [Equation 6]

Here, Reg(A) may mean a regular symmetric affinity matrix, A may mean a dynamic graph matrix, and A^{T} may mean a transposition affinity matrix.

In addition, the regular symmetric affinity matrix generated by the affinity fusion unit 120 may be replaced with a dynamic graph matrix to be used by the pose estimation unit 130 to be described later.

Meanwhile, the pose estimation unit 130 may replace the static graph matrix of the graph convolution network with a dynamic graph matrix to estimate the 3D pose of the object for the feature vector.

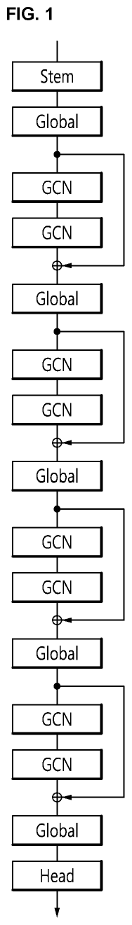

Specifically, in FIG. 1, except for the stem layer (stem), a 3D pose may be estimated by replacing a static graph matrix Ã used in the GCN with a dynamic graph matrix generated through the affinity fusion unit 120.

In addition, when the affinity fusion unit 120 calculates the regular symmetric affinity matrix according to the regular symmetric constraints, the pose estimation unit 130 may replace the static graph matrix with the regular symmetric affinity matrix to estimate the 3D object for the feature vector.

First, the GCN will be briefly described. A graph [symbol] ={V,ϵ} can be defined as a set comprising a set of J nodes, V, and a set of edges, ϵ. Each ith node has a joint feature hᵢ∈ [symbol] , and a set of hᵢ can be expressed as a feature matrix H∈ [symbol] . And the formula for the output feature vector H′ is shown in Equation 7 below.

H′=σ(WHÃ) [Equation 7]

Here, σ is a ReLU activation function, W may be a learnable weight matrix, and Ã may mean a static graph matrix as described above. Ã is

$$\tilde{A} = {\tilde{D}}^{- \frac{1}{2}} ( A + I ) {\tilde{D}}^{- \frac{1}{2}} ,$$

which can be obtained with the identity matrix I, the graph adjacency matrix A∈[0,1]^{J×J}, and \tilde{D}, which is the diagonal matrix of A+I.

In this case, Ã may be replaced with the dynamic graph matrix generated by the affinity fusion unit 120.

And, for the ith node, \tilde{α}ᵢⱼ is the (i,j)th element of Ã(\tilde{α}ᵢⱼ is not 0, i, j={1, J}), and [symbol] is the set of neighboring nodes of the ith node and [symbol] = [symbol] +{i}. And the ith element of the input feature vector H is called hᵢ, and the ith element of the output feature vector H′ is called h′ᵢ.

These GCNs can be classified in various ways according to the method of sharing weights. For example, it may be a vanilla GCN, a pre-aggregation GCN, a post-aggregation GCN, a no-sharing GCN, a convolution-style GCN, a modulated GCN, and the like.

First, the vanilla GCN is a full-sharing strategy, and the formula for obtaining h′ᵢ can be defined as in Equation 8 below.

$${h}_{i}^{′} = σ ( {\sum }_{j ∈ \tilde{{𝒩}_{i}}} W {h}_{j} {\tilde{a}}_{ij} ) \qquad [ Equation 8 ]$$

On the other hand, the pre-aggregation GCN has different weights for each node and updates the features using a weight matrix
Wⱼ∈ [symbol] (j∈{1, . . . , J}) before integrating the features. The formula for obtaining h′ᵢ may be the same as Equation 9. Here, D of the weight matrix may be the dimension of the input feature vector, and D′ may mean the dimension of the output feature vector.

$${h}_{i}^{′} = σ ( {\sum }_{j ∈ \tilde{{𝒩}_{i}}} {W}_{j} {h}_{j} {\tilde{a}}_{ij} ) \qquad [ Equation 9 ]$$

The post-aggregation GCN also has different weights for each node, and updates features using the weight matrix Wᵢ∈ [symbol] (i∈{1, . . . , J}) after integrating the features. The formula for obtaining h′ᵢ may be the same as Equation 10.

$${h}_{i}^{′} = σ ( {W}_{i} {\sum }_{j ∈ \tilde{{𝒩}_{i}}} {h}_{j} {\tilde{a}}_{ij} ) \qquad [ Equation 10 ]$$

On the other hand, the no-sharing GCN does not share weights, has different weights for each edge, and updates features by applying a weight matrix Wᵢⱼ∈ [symbol] (i,j∈{1, . . . , J}) for each edge. The formula for obtaining h′₁ may be the same as Equation 11.

$${h}_{i}^{′} = σ ( {\sum }_{j ∈ \tilde{{𝒩}_{i}}} {W}_{ij} {h}_{j} {\tilde{a}}_{ij} ) \qquad [ Equation 11 ]$$

And, the convolution-style GCN is a method that uses a kernel grid like a convolution operation. This convolution-style GCN assigns different weights according to the phase difference between two nodes connected to the edge. When the phase difference d between the two nodes is defined as d(i,j)∈{−1, 0, 1}, the formula for obtaining h′ᵢ according to the weight matrix W_{d(i,j)}∈ [symbol] may be as shown in Equation 12.

$${h}_{i}^{′} = σ ( {\sum }_{j ∈ \tilde{{𝒩}_{i}}} {W}_{d ( i , j )} {h}_{j} {\tilde{a}}_{ij} ) \qquad [ Equation 12 ]$$

On the other hand, the modulated GCN is an advanced version of the above-mentioned no-sharing GCN, and uses a learnable modulated vector mⱼ∈ [symbol] for each node. In addition, the formula for obtaining in the modulated GCN may be as shown in Equation 13.

$${h}_{i}^{′} = σ ( {\sum }_{j ∈ \tilde{{𝒩}_{i}}} ( {m}_{j} ⊙ W ) {h}_{j} {\tilde{a}}_{ij} ) \qquad [ Equation 13 ]$$

In this case, the pose estimation unit 130 may perform decouple self-connections when the vanilla GCN, pre-aggregation GCN, and post-aggregation GCN are used among the above methods of sharing the weights.

Since the normalized graph matrix generally used by the GCN includes self-connection, the pose estimation unit 130 may separate the relationship information between nodes and perform decouple self-connections using separate learnable weight parameters for self-connected edges.

Since self-connection does not include relationships between nodes, in order to maximize learning about node relationships for feature representation, the pose estimation unit 130 may separate relationship information by performing decouple self-connections.

Formulas for the pose estimation unit 130 to perform decouple self-connections may be the same as Equations 14 to 16 below.

$${h}_{i}^{′} = σ ( {Th}_{i} {\tilde{a}}_{ii} + {\sum }_{j ∈ \tilde{{𝒩}_{i}}} W {h}_{j} {\tilde{a}}_{ij} ) \qquad [ Equation 14 ]$$

$${h}_{i}^{′} = σ ( {T}_{i} {h}_{i} {\tilde{a}}_{ii} + {\sum }_{j ∈ \tilde{{𝒩}_{i}}} {W}_{j} {h}_{j} {\tilde{a}}_{ij} ) \qquad [ Equation 15 ]$$

$${h}_{i}^{′} = σ ( {T}_{i} {h}_{i} {\tilde{a}}_{ii} + {W}_{i} {\sum }_{j ∈ \tilde{{𝒩}_{i}}} {h}_{j} {\tilde{a}}_{ij} ) \qquad [ Equation 16 ]$$

Equation 14 above is for the case of using the vanilla GCN, Equation 15 is for the case of using the pre-aggregation GCN, and Equation 16 is for the case of using the post-aggregation GCN.

Here, T∈ [symbol] and Tᵢ∈ [symbol] may mean a learnable weight matrix for a self-connected edge.

Accordingly, the apparatus 100 of the present invention can greatly improve the performance of estimating a 3D pose while almost maintaining the memory usage and inference time of the existing graph convolution network (GCN).

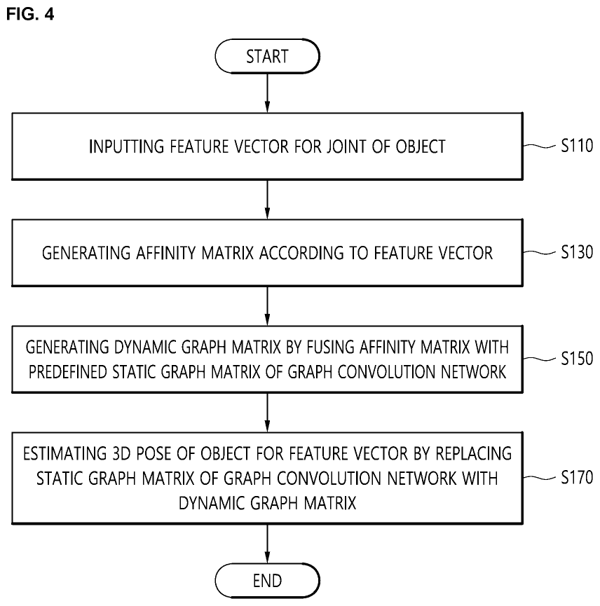

Meanwhile, FIG. 4 is a flowchart for describing a pose estimation method in the 3D pose estimation apparatus 100 according to an embodiment of the present invention. Since the pose estimation method according to an embodiment of the present invention proceeds on substantially the same configuration as the 3D pose estimation apparatus 100 shown in FIGS. 2 and 3, the same reference numerals are assigned to the same components as those of the 3D pose estimation apparatus 100 shown in FIGS. 2 and 3, and repeated descriptions will be omitted.

The pose estimation method of the present invention is performed in a 3D pose estimation apparatus 100 that estimates a 3D pose of an object based on a graph convolution network (GCN).

In addition, the pose estimation method of the present invention may comprise inputting a feature vector (S110), generating an affinity matrix (S130), generating a dynamic graph matrix (S150), and estimating a 3D pose (S170).

The step of inputting a feature vector (S110) may be a step of inputting feature vectors or the joints of the object. In the step of inputting the feature vectors S110), the affinity generation unit 110 may receive a feature vector for the joint of the object. The feature vector for the joint of the object may be information corresponding to a feature extracted based on 2D joint coordinates given as an input.

In the step of generating an affinity matrix (S130), the affinity generation unit 110 may generate an affinity matrix according to the input feature vector.

The step of generating the affinity matrix (S130) may comprise a step, in which the affinity generation unit 110 applies a routing function (ROUTE FN) to the feature vector to predict weights to be applied to a plurality of predefined expert matrices.

Specifically, in the step of generating an affinity matrix (S130), as shown in Equation 1 described above, the affinity generation unit 110 may predict the weights to be applied to the E expert matrices by applying the feature vector, which is the joint feature for each node of the graph, to the routing function (ROUTE FN) as an input vector h.

The step of generating the affinity matrix (S130) may comprise the step of generating the affinity matrix by the affinity generation unit 110 as a weighted sum of the predicted weights and a plurality of expert matrices.

At this time, the affinity generation unit 110 may generate an affinity matrix ϵ_{cond} for an input vector h, which is a feature vector, as input according to Equation 2 described above.

Meanwhile, the step of generating a dynamic graph matrix (S150) may be performed to apply the affinity matrix generated in the step of generating an affinity matrix (S130) to a graph matrix used in a graph convolution network (GCN).

In the step of generating such a dynamic graph matrix (S150), the affinity fusion unit 120 may generate a dynamic graph matrix by fusing the affinity matrix and a predefined static graph matrix of the graph convolution network.

In this case, the predefined static graph matrix may mean a feature based on a general skeletal structure of the human body. In addition, the generated affinity matrix may mean a feature of an object only.

In other words, the predefined static graph matrix is based on a universal human body structure, and the affinity matrix may mean gender, age, or a unique structure that only a corresponding object has.

To this end, in the step of generating a dynamic graph matrix according to an embodiment of the present invention (S150), the dynamic graph matrix can be generated in various ways.

In the step of generating the dynamic graph matrix (S150), the affinity fusion unit 120 may perform a multiplication modulation using an element-by-element multiplication operation of the affinity matrix and a predefined static graph matrix to generate a dynamic graph matrix according to an embodiment.

In addition, in the step of generating the dynamic graph matrix (S150), the affinity fusion unit 120 may perform an additional modulation using a summation operation of the affinity matrix and the predefined static graph matrix to generate the dynamic graph matrix according to another embodiment.

In the step of generating the dynamic graph matrix (S150), the affinity fusion unit 120 may generate the dynamic graph matrix using only the affinity matrix according to another embodiment.

Also, in the step of generating a dynamic graph matrix (S150), the affinity fusion unit 120 may use only a predefined static graph matrix without using the generated affinity matrix. That is, modulation may not be performed.

In addition, if an unexpected matrix is generated in the process of performing affinity modulation according to the various methods described above, it may adversely affect the estimation of the overall 3D pose.

In order to prevent this, in the step of generating a dynamic graph matrix (S150), a step of performing a transposition operation on the dynamic graph matrix to calculate a transposition affinity matrix, and a step of calculating a regular symmetric affinity matrix by using an average operation of the dynamic graph matrix and the transposition affinity matrix may be additionally performed.

Meanwhile, in the step of estimating the 3D pose (S170), the pose estimation unit 130 may estimate the 3D pose of the object for the feature vector by replacing the static graph matrix of the graph convolution network with a dynamic graph matrix.

In the step of estimating the 3D pose (S170), if the normal symmetric affinity matrix is calculated in the step of generating the dynamic graph matrix (S150), a 3D pose of the object for the feature vector may be estimated by replacing the static graph matrix with the regular symmetric affinity matrix.

Such a pose estimation method of the present invention may be implemented in the form of program instructions that can be executed through various computer components and recorded on a computer-readable recording medium. The computer-readable recording medium may include program instructions, data files, data structures, etc. alone or in combination.

Program instructions recorded on the computer-readable recording medium may be specially designed and configured for the present invention, or may be known and usable to those skilled in the art of computer software.

Examples of computer-readable recording media may comprise magnetic media such as hard disks, floppy disks, and magnetic tapes, optical recording media such as CD-ROMs and DVDs, magneto-optical media such as floptical disks, and hardware devices specially configured to store and execute program instructions, such as ROM, RAM, flash memory, and the like.

Examples of program instructions include high-level language codes that can be executed by a computer using an interpreter or the like as well as machine language codes generated by a compiler. The hardware device may be configured to act as one or more software modules to perform processing according to the present invention and vice versa.

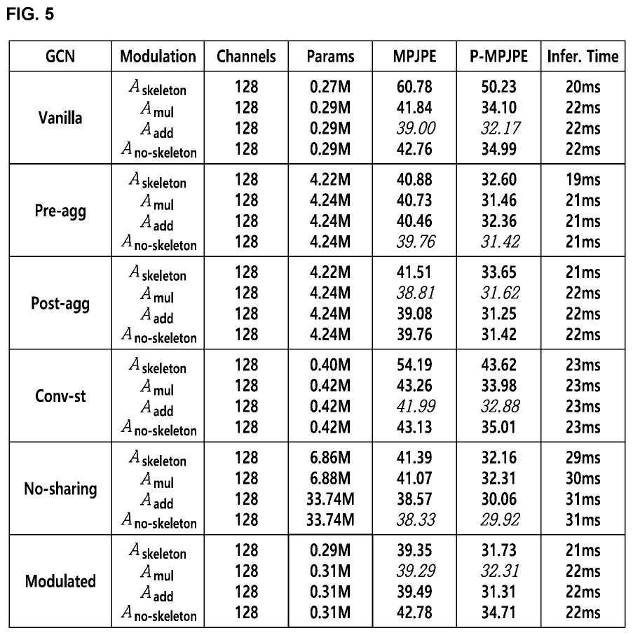

Meanwhile, FIGS. 5 to 9 are experimental results for describing the effect of the pose estimation method according to an embodiment of the present invention.

The dataset for the experiment used the Human3.6M dataset, and the evaluation method also followed the standard evaluation procedure. The Human3.6M data set provides 3D posture data captured in an indoor motion capture environment, and includes 15 motions performed by 7 actors from 4 viewpoints. In the experiment of the present invention, items S1, S5, S6, S7, and S8 were used as training data (1,559,752 frames), and items S9 and 511 were used as test data (543,334 frames). The loss function used in all experiments used the weighted sum of L2 loss and L1 loss between the predicted value and the actual value as shown in Equation 17 below.

Loss=(1−λ)*L2(Pred,GT)+λ*L1(Pred,FT) [Equation 17]

In all experiments, λ was fixed at 0.1.

There are two common evaluation protocols used in Human3.6M.

First, the evaluation index MPJPE (Mean Per-Joint Position Error) uses the average of the Euclidean distance (mm) between the two points after aligning the predicted relative joint position (Pred) and the actually measured joint position (ground truth, GT) for the root joint, which is called protocol #1.

On the other hand, P-MPJPE (Procrustes analysis Mean Per-Joint Position Error) uses the average of Euclidean distances (mm) derived by equidistant transformation from prediction to GT, which is called Protocol #2.

Ablation studies use 2D poses of GT, but quantitative comparisons with other studies use 2D poses predicted by cascaded pyramid networks (CPNs).

The same learning parameters were used for all ablation studies to test whether there is a performance-enhancing effect when applying the present invention. All models to be tested are implemented in PyTorch and Adam optimization algorithm was used. Additionally, all experiments were performed on a single NVIDIA RTX 3090 GPU.

In the ablation study, the initial learning rate was set to 0.001, the decay coefficient to 0.96 per 25,000 iterations, the batch size to 256, and the total epoch to 50. Variability due to random variables was minimized by comparing using the median value of three learning results. In addition, the depth of the layer was fixed at 4 (inheritance of the method of existing models), and the dropout ratio was fixed at 0.0.

In a quantitative comparison study with other studies, the initial learning rate was set to 0.005, the decay coefficient to 0.65 per 25,000 iterations, the total epoch to 30, and the dropout ratio to 0.2.

In addition, in the experiment of the present invention, a comprehensive ablation study was performed on the Human3.6M data set, and for the ablation study, the above-described vanilla GCN, pre-aggregation GCN, post-aggregation GCN, no-sharing GCN, convolution-style GCN, and modulated GCN were selected to test the effect of the present invention. And decoupled self-connection was applied only to the vanilla GCN, pre-aggregation GCN, and post-aggregation GCN.

First, an ablation study proceeds on the modulation method used for affinity modulation. Then, the effect on the performance of adjusting the number of expert matrices used to generate the affinity matrix was tested. Finally, the performance improvement effect of affinity normalization was tested. In the ablation study, errors due to variables of the 2D posture detector were minimized by using the GT of the 2D posture as an input vector.

First, an ablation study on affinity modulation will be described.

Affinity modulation was applied in the three methods of the present invention as described above to test the performance improvement effect. And since Aₛₖₑₗₑₜₒₙ is the same as the graph structure used in the existing GCN method, it is used as a comparison group.

In the experiment, training was conducted with a 128-channel model, and the number of expert matrices used in the experiment was fixed at 6. As a result, as shown in FIG. 5, it can be seen that the modulation of all GCNs, to which the estimation method of the present invention is applied, shows improved performance compared to the predefined static graph matrix Aₛₖₑₗₑₜₒₙ based on protocol #1.

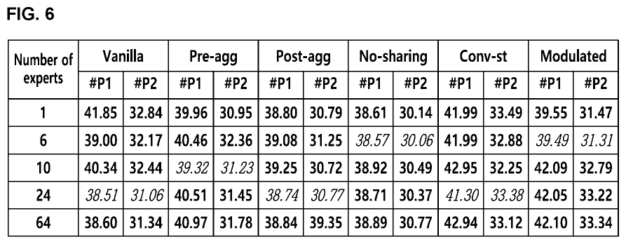

On the other hand, experiments for ablation studies according to the number of expert matrices were conducted to find out the effect of the number of expert matrices on performance. For the experiment, among the above-described modulation methods, A_{add}, which is an additional modulation method using a summation operation was applied, but the number of expert matrices was changed. In the experiment, all models were fixed to 128 channels, and the experimental results are shown in FIG. 6. As shown in FIG. 6, it can be seen that the number of expert matrices producing the best performance is different for each GCN method, and the performance decreases when the number of expert matrices exceeds a certain convergence value.

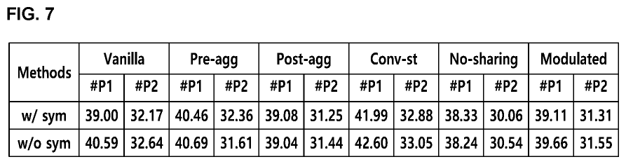

In addition, the experiment for the effect of the regular symmetry constraint was performed by fixing the number of expert matrices to 6 in the same parameter setting as the experiment in the ablation study according to the number of expert matrices. The result is as shown in FIG. 7. In FIG. 7, the result to which the regular symmetric constraint is applied is w/ sym, and the result to which the regular symmetric constraint is not applied is w/o sym.

As shown in the figure, when the regular symmetric constraints were applied to all methods, there was an effect of improving performance.

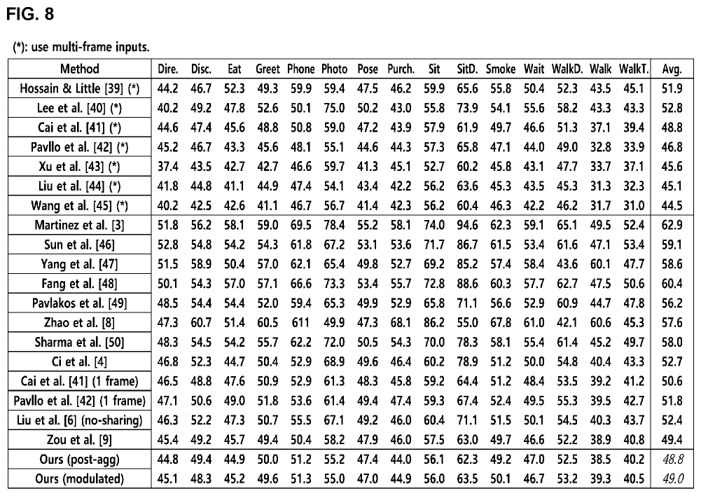

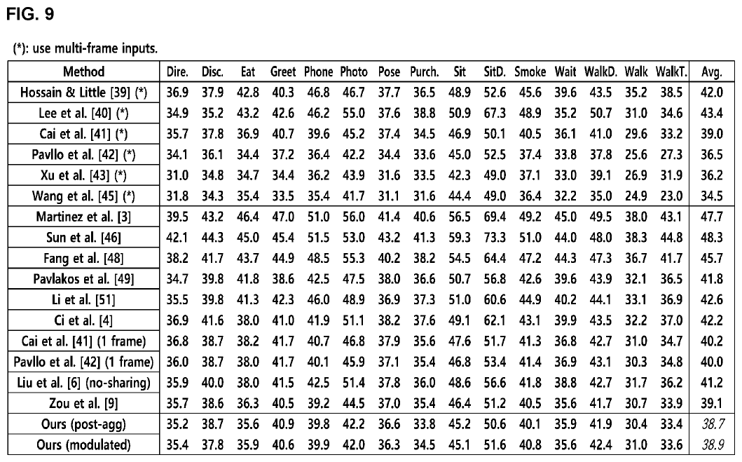

Meanwhile, FIGS. 8 and 9 are the comparison results of the estimation method of the present invention, which performs an affinity modulation for generating an affinity matrix and a dynamic graph matrix, with other up-to-date methods for Human 3.6M.

For comparison, the 2D joint coordinates of the human body posture detected by the cascaded pyramid network (CPN) were used as input.

As shown in FIGS. 8 and 9, it can be seen that the estimation method according to an embodiment of the present invention improves only performance while almost maintaining the inference time and memory usage of the existing method, and outperforms all other GCN-based methods, except for heavy models using multi-frame data as input.

In addition, the estimation method according to the present invention has the advantage of high versatility because it can be applied to GCN-based models that have already been presented or will be developed in the future.

In addition, the estimation method according to the present invention can overcome limitations due to a fixed graph structure through an affinity matrix that is dynamically modulated according to input features, that is, a dynamic graph matrix.

Although various embodiments of the present invention have been shown and described above, the present invention is not limited to the specific embodiments described above. Various modifications and implementations are possible by those skilled in the art to which the invention pertains without departing from the gist of the invention claimed in the claims, and these modified implementations should not be individually understood from the technical spirit or perspective of the present invention.

### REFERENCE NUMERAL

100: 3D pose estimation apparatus
110: affinity generation unit
120: affinity fusion unit
130: pose estimation unit

1. A pose estimation method in a 3D pose estimation apparatus for estimating a 3D pose of an object based on a graph convolution network (GCN) comprising:
inputting a feature vector for a joint of the object;
generating an affinity matrix according to the feature vector;
generating a dynamic graph matrix by fusing the affinity matrix with a predefined static graph matrix of the graph convolution network; and
estimating a 3D pose of the object for the feature vector by replacing the static graph matrix of the graph convolution network with the dynamic graph matrix.

2. The method of claim 1, wherein generating the affinity matrix comprises,
predicting a weight to be applied to a plurality of predefined expert matrices by applying a routing function to the feature vector; and
generating the affinity matrix as a weighted sum of the predicted weight and the plurality of expert matrices.

3. The method of claim 1, wherein generating the dynamic graph matrix comprises,
generating the dynamic graph matrix by performing a multiplication modulation using an element-by-element multiplication operation of the affinity matrix and the predefined static graph matrix.

4. The method of claim 1, wherein generating the dynamic graph matrix comprises,
generating the dynamic graph matrix by performing an additional modulation using a summation operation of the affinity matrix and the predefined static graph matrix.

5. The method of claim 1, wherein generating the dynamic graph matrix comprises,
generating the dynamic graph matrix using only the affinity matrix.

6. The method of claim 1, wherein generating the dynamic graph matrix comprises,
calculating a transposition affinity matrix by performing a transposition operation on the dynamic graph matrix; and
calculating a regular symmetric affinity matrix using an average operation of the dynamic graph matrix and the transposition affinity matrix,
wherein estimating the 3D pose of the object comprises,
estimating the 3D pose of the object for the feature vector by replacing the static graph matrix with the regular symmetric affinity matrix.

7. A computer-readable recording medium, on which a computer program for performing the pose estimation method according to claim 1 is recorded.

8. A 3D pose estimation apparatus for estimating a 3D pose of an object based on a graph convolution network (GCN) comprising:
an affinity generation unit for inputting a feature vector for a joint of the object and generating an affinity matrix according to the feature vector;
an affinity fusion unit for generating a dynamic graph matrix by fusing the affinity matrix with a predefined static graph matrix of the graph convolution network; and
a pose estimation unit for estimating a 3D pose of the object for the feature vector by replacing the static graph matrix of the graph convolution network with the dynamic graph matrix.

9. The apparatus of claim 8, wherein the affinity generation unit predicts a weight to be applied to a plurality of predefined expert matrices by applying a routing function to the feature vector and generates the affinity matrix as a weighted sum of the predicted weight and the plurality of expert matrices.

10. The apparatus of claim 8, wherein the affinity fusion unit generates the dynamic graph matrix by performing a multiplication modulation using an element-by-element multiplication operation of the affinity matrix and the predefined static graph matrix.

11. The apparatus of claim 8, wherein the affinity fusion unit generates the dynamic graph matrix by performing an additional modulation using a summation operation of the affinity matrix and the predefined static graph matrix.

12. The apparatus of claim 8, wherein the affinity fusion unit generates the dynamic graph matrix using only the affinity matrix.

13. The apparatus of claim 8, wherein the affinity fusion unit calculates a transposition affinity matrix by performing a transposition operation on the dynamic graph matrix and calculates a regular symmetric affinity matrix using an average operation of the dynamic graph matrix and the transposition affinity matrix,
wherein the pose estimation unit estimates the 3D pose of the object for the feature vector by replacing the static graph matrix with the regular symmetric affinity matrix.
